(19) United States
(12) Patent Application Publication
(10) Pub. No.: US 2003/0009711 A1
(43) Pub. Date: Jan. 9, 2003

(54) Alarm management system

(76) Inventors: Gerald M. Kuhn, Berkeley, CA (US); Maarten Koning, Bloomfield (CA); Remi Cote, Hull (CA); Kevin McCombe, Ottawa (CA); Paola Rossaro, San Francisco, CA (US)

Correspondence Address: Davidson, Davidson & Kappel, LLC, 14th Floor, 485 Seventh Avenue, New York, NY, 10018, US

(21) Appl. No.: 09/894,433

(22) Filed: Jun. 28, 2001

(51) Int. Cl. G05B 9/02

(52) U.S. Cl. 714/57; 700/80

(57) ABSTRACT

An alarm management system is provided which includes a hierarchical database of alarm source identifiers. Each alarm source identifier is associated with a corresponding software entity capable of generating an alarm. The system further includes a corresponding alarm controller for each software entity and an alarm processor. The alarm processor receives an alarm from one of the software entities, accesses the hierarchical database to identify a parent software entity of the one of the software entities, invokes a corresponding alarm controller for the one of the software entities and invokes a corresponding alarm controller for a corresponding alarm controller for the parent software entity.

### BACKGROUND

A fault is an unusual event that requires adaptive actions on the part of a computer system. In this regard, a fault is not necessarily a negative event. A fault can be a notification or warning about a change in condition, or can simply serve as statistical data on system operation. A fault can be caused by software or hardware conditions. For example, faults can include hardware-generated exceptions, error paths in the code, or thresholds crossed. An alarm is a software representation of a fault.

In prior art systems, when an application (be it the kernel or a higher level application) determines out that a fault has occurred somewhere in the system, the application itself is charged with finding a recovery mechanism and with reporting the fault as an alarm to other users of the system. In complex systems, it is extremely difficult to resolve faults with routines triggered locally.

### SUMMARY

In accordance with a first embodiment of the present invention, an alarm management system is provided which includes a hierarchical database of alarm source identifiers. Each alarm source identifier is associated with a corresponding software entity capable of generating an alarm. The alarm processor receives an alarm from one of the software entities, invokes a corresponding alarm controller for the one of the software entities, accesses the hierarchical database to identify a parent software entity of the one of the software entities, and invokes a corresponding alarm controller for a corresponding alarm controller for the parent software entity.

In accordance with a second embodiment of the present invention, an alarm management system is provided which includes an alarm processor and a hierarchical database of alarm source identifiers. Each alarm source identifier is associated with a corresponding software entity capable of generating an alarm and a corresponding alarm hook is provided for each software entity. A plurality of alarm handlers are also provided and each software entity is associated with at least one of the alarm handlers. The alarm processor receives an alarm from one of the software entities and invokes the corresponding alarm hook. In addition, the alarm processor invokes the at least one alarm handler for the one of the software entities, accesses the hierarchical database to identify a parent software entity of the one of the software entities based upon the alarm source identifier associated with the one of the software entities, and invokes the at least one alarm handler associated with the parent software entity.

In accordance with a third embodiment of the present invention, a method for responding to an alarm is provided which includes the steps of receiving an alarm from one of a plurality of software entities, identifying a parent software entity of the one of the software entities, invoking a corresponding alarm controller for the one of the software entities; and invoking a corresponding alarm controller for the parent software entity.

In accordance with a fourth embodiment of the present invention, a method for responding to an alarm is provided which comprises the steps of receiving an alarm from one of a plurality of software entities invoking a corresponding alarm hook, invoking the at least one alarm handler for the one of the software entities, invoking the at least one alarm handler for the one of the software entities, and accessing a hierarchical database of alarm source identifiers. In this regard, each alarm source identifier is associated with a corresponding software entity of the plurality of software entities. The method further includes the steps of identifying a parent software entity of the one of the software entities based upon the alarm source identifier associated with the one of the software entities, and invoking the at least one alarm handler associated with the parent software entity.

In accordance with a fifth embodiment of the present invention, an alarm management system is provided that includes a plurality of software entities capable of generating an alarm, a hierarchical database of alarm source identifiers, a plurality of alarm hooks, a plurality of alarm handlers, and an alarm processor. Each alarm source identifier is associated with a corresponding one of the software entities, each alarm hook is associated with one of the software entities, and each alarm handler is associated with one or more of the software entities. The alarm processor receives an alarm from one of the software entities and invokes any alarm hook associated with the one of the software entities. The alarm processor also invokes any alarm handlers associated with the one of the software entities, accesses the hierarchical database to identify a parent software entity of the one of the software entities based upon the alarm source identifier associated with the one of the software entities, and invokes any alarm handlers associated with the parent software entity.

In accordance with other embodiments of the present invention, computer readable media are provided which have stored thereon computer executable process steps operable to control a computer to implement the first, second, third, and fourth embodiments described above.

### BRIEF DESCRIPTION OF DRAWINGS

FIG. 1(a) shows an illustrative alarm management system in accordance with the present invention.

FIG. 1(b) shows the flow patterns of the system of FIG. 1(a).

FIG. 1(c) shows a simplified alarm management system in accordance with the present invention.

FIG. 2 shows a flow chart for the alarm manager of FIGS. 1(a, b).

FIG. 3(a) shows an exemplary OMS tree.

FIG. 3(b) shows an example of alarm escalation.

### DETAILED DESCRIPTION OF THE PREFERRED EMBODIMENTS

An Alarm Management System (“AMS”) is provided in accordance with a preferred embodiment the present invention to manage alarms generated by applications running on a system. Upon finding a fault, an application injects an alarm into the AMS. An alarm is thus the software representation of a fault. Viewed another way, a fault can be considered an event, and the alarm its software representation. The alarm is injected into the AMS after the application that defected the fault has reacted to it. However, not every fault need result in an alarm injection. For example, if a fault needs a fast response and the application knows how to respond to the fault, the application may simply respond to the fault without involving the AMS. The application may also decide that nothing else needs to be done with the fault and that no alarms need to be generated. On the other hand, the application may not know how to deal with the fault. In that case, an alarm representing the fault is injected into the AMS for further treatment and possibly fault recovery. The AMS then passes the alarm on to other applications in the system that might have more knowledge about how to respond to the fault.

In accordance with an embodiment of the present invention, the AMS includes a database of potential alarm sources, an alarm injection layer, an alarm manager, and a plurality of alarm controllers. Preferably, the alarm controllers include alarm hooks and alarm handlers.

The database of potential alarm sources is organized in a hierarchical structure (such as a tree, linked list, etc.). For purposes of this discussion, the database will be referred to as an Object Management System (OMS), the hierarchical structure will be referred to as the OMS tree, and the root node of the OMS tree will be called “oms”. The relationship between nodes in the database can be described in terms of parent, child, sibling, ancestor, and descendants nodes. Nodes of the OMS tree can be referred to as managed objects, and users of the system can choose how they want to represent their system in the OMS tree. In other words, the hierarchical relationship between the nodes representing the potential alarm sources is user configurable.

Alarms enter the AMS through the alarm injection layer (AIL), and the AIL provides the necessary alarm information to the alarm manager. The alarm manager is responsible for implementing the alarm dispatching policies. In that role, the alarm manager calls the proper alarm hooks and alarm handlers in the appropriate order based upon a predetermined protocol.

Alarm hooks are defined at the alarm source level. A different alarm hook can be defined for every potential alarm source found in the OMS tree. Moreover, only one hook can be defined per potential alarm source. Alarm hooks are called in the context of the alarm injection call from the AIL to allow for immediate response to an alarm. In general, the goal of the alarm hook is to attempt to: i) ensure that the system is not in a critical situation because of the alarm, and ii) ensure that the system is in a stable state. In general, the (usually) more lengthy process of actually fixing the problem raised through the alarm is left to the various alarm handlers. It should be appreciated, however, that the actual actions that a given alarm hook or alarm handler perform are user-defined and therefore may or may not, in any given context achieve these goals.

Alarm handlers are also defined at the alarm source level. However, more than one alarm handler can be defined per alarm source. Alarm handlers are not called in the context of the alarm injection call. Rather, they are called from an alarm dispatcher task, which usually runs at a lower priority than the alarm injection call. This architecture is based on the assumption that the system is usually in a relatively stable state by the time the alarm handlers are invoked. In general, the alarm handlers attempt to return all services that have been affected by the cause of the alarm to their original state.

A preferred alarm processing protocol will now be described with regard to a hypothetical OMS tree having a root node “oms” having two children obj1 and obj2, wherein obj1 has two children obj3 and obj4, and wherein obj2 has no children. If an alarm is injected on obj3, the alarm would be provided to the AIL, and the AIL, in turn, would pass the alarm on to the alarm manager. The alarm manager would then i) call the alarm hook registered with the alarm source (obj3); and ii) pass the information pertaining to the alarm on to the alarm management task. The alarm management task then calls all of the alarm handlers registered with obj3. Once the alarm handlers for the alarm source (obj3) have been called, the alarm manager begins an escalation process by calling all the alarm handlers registered with the parent of the alarm source in the OMS tree (obj1). The alarm management task will then continue the escalation process, calling the parent of a current alarm source and invoking the parent's alarm handlers until the escalation process reaches root node “oms” of the OMS tree and calls the alarm handlers registered with the root node. Preferably, the escalation process continues regardless of whether or not the alarm has been cleared.

In accordance with a further embodiment of the present invention, alarm filtering can be provided. Alarm filtering allows a user to prevent the alarm manager from invoking a particular alarm handler when certain filtering criteria are met. In this regard, when the alarm handler is registered with an alarm source, a set of filter criteria can be provided to define when the alarm handler should be called. If an alarm does not correspond to the criteria defined by an alarm handler, then the alarm manager will not call this alarm handler during the escalation process of that alarm. A typical example of a filter criteria would be the severity of the alarm.

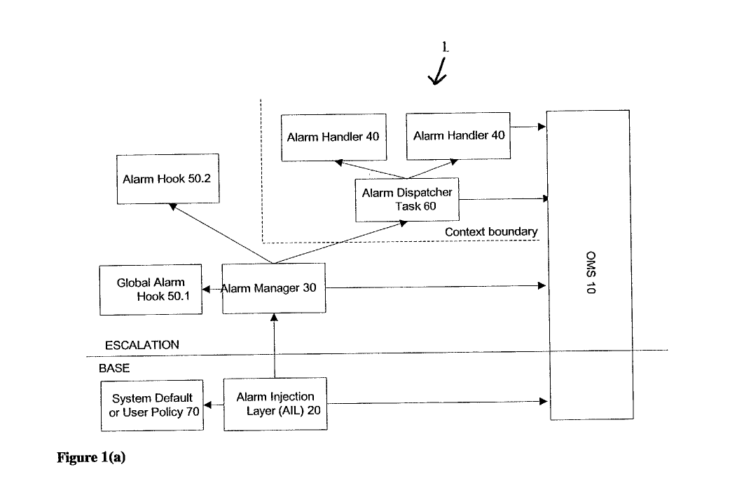

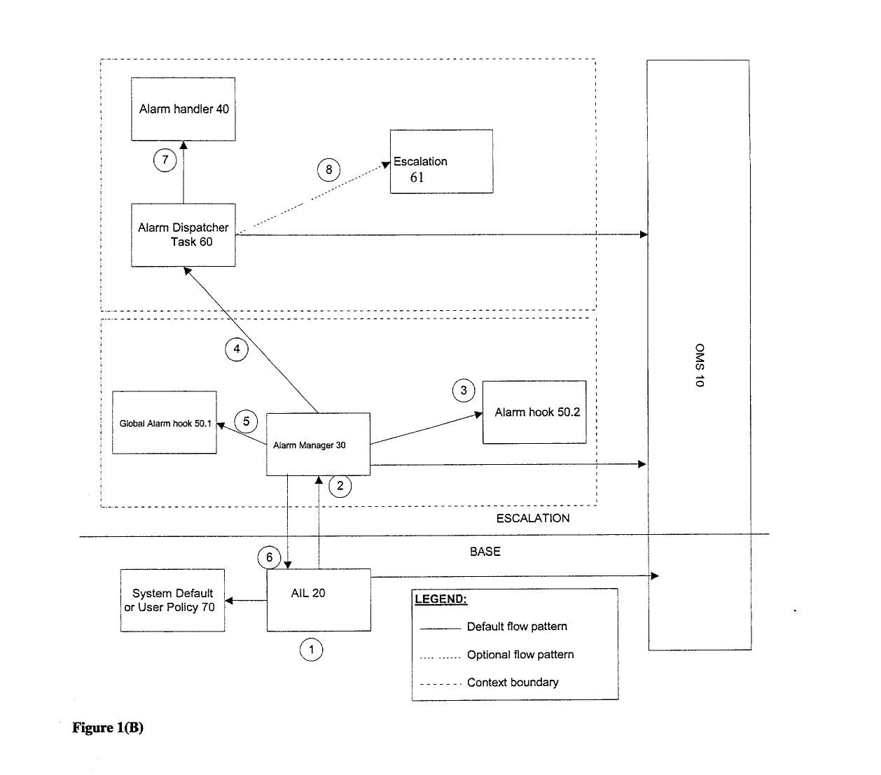

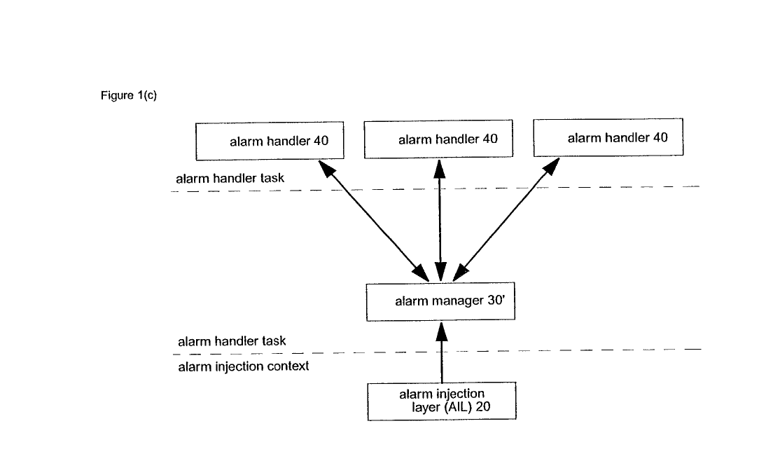

An overview of an alarm management system in accordance with a preferred embodiment of the present invention is shown in FIGS. 1(a, b). The AMS 1 includes the following components: the Object Management System 10 (OMS), the Alarm Injection Layer (AIL) 20, the alarm manager 30, the alarm handler(s) 40, the alarm hooks 50, and an Alarm Dispatcher Task 60. As described above, alarm hooks 50 and alarm handlers 40 represent the functions provided by the user to perform specific actions in response to faults. In addition, a user default policy 70 can be applied to replace and/or precede a system default policy (e.g. the default fault response of the system, such as reboot). The architecture of FIG. 1(a, b) includes two layers: a base layer and an escalation layer. This layered architecture enables scaling of the system in that only AIL and OMS need be included to provide an API that allows hardened applications to run on a kernel that doesn't include an alarm escalation feature. The layered architecture also supports the addition of multiple independent alarm hooks/handlers. This, for example, allows one alarm handler to connect a fault management framework to the alarm manager and another alarm handler to deal with the logging of alarms.

Although the system is shown in FIGS. 1(a, b) as including alarm hooks 50 and alarm handlers 40, it should be appreciated that the system can alternatively be configured to include only the alarm handlers 40. Referring to FIG. 1(c), a simplified system including only alarm handlers 40 is shown, with the invocation of the handlers controlled by an alarm manager 30′. It should be appreciated that in the embodiment of FIG. 1(c), the alarm manager 30′ performs the applicable functions of the alarm manager 30 and the alarm dispatcher task 60 of FIG. 1(a) for invoking and processing of alarm handlers. Therefore, it should be understood that while the present invention is described below with regard to the system configuration of FIG. 1(a), the procedures for invoking and processing of alarm handlers apply equally to the system configuration of FIG. 1(c).

An alarm (which is software representation of a fault) is generated by the code that detects the fault. Once the alarm is generated, it is said that its state is set. If the system has successfully acted on the alarm, then it is said that the alarm state is clear. Alarms have other information associated with them, such as the conditions which generated an alarm, a description of the type of alarm, and the source that generated it. This information is received by AMS 1 and passed to the user defined actions via the alarm handlers 40 and alarm hooks 50.

The Object Management System (OMS) 10 is responsible for the naming of managed objects (software or hardware) that can be a source of alarms. The OMS 10 has a hierarchical tree structure and allows managed objects to be registered dynamically. The OMS 10 provides a mechanism for organizing abstract entities within a system into a hierarchical tree. These entities, called managed objects, can represent hardware, software such as drivers, or any other kind of abstraction. When an alarm is escalated, it follows the OMS tree.

Users control how their system is represented in the OMS tree. A node in a managed object tree can be created, for example, via a function that takes a specified parent node as an argument and creates a child node below it in the tree. As described above, a permanent node (e.g. called “oms”) provides the root of the managed object tree.

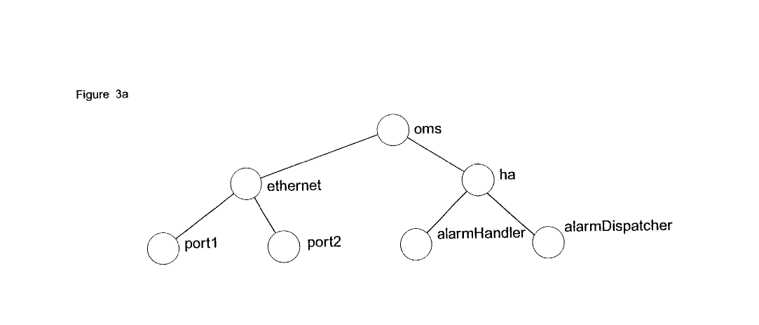

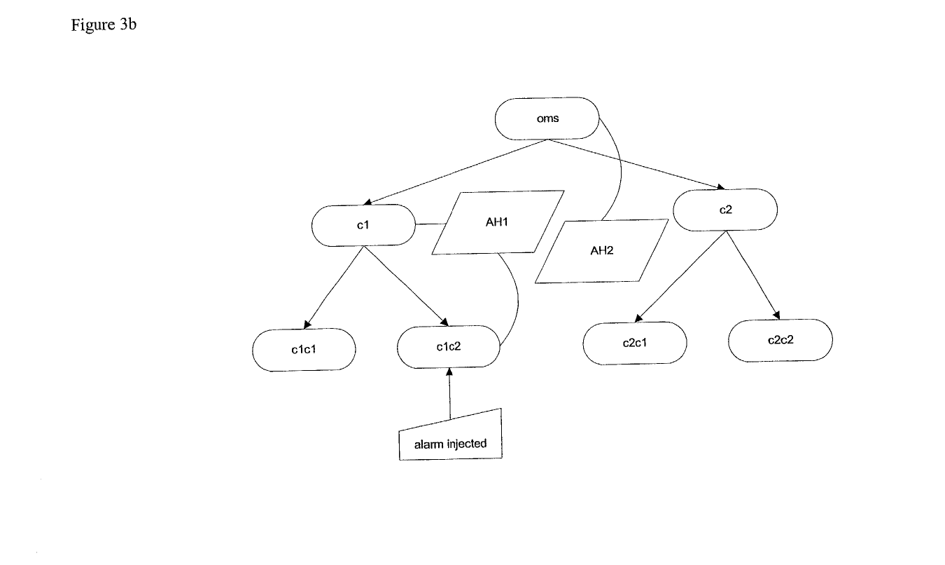

FIG. 3(a) shows a simple example of how a system might be described using the OMS10. In this example, the root of the OMS tree has two children, ha and ethernet. The “ha” node is a software module with two child software modules, alarmHandler and alarmDispatcher. The ethernet node is a device driver with two child instances representing two hardware ports, port 1 and port 2. Each node in this tree is a managed object and is capable of injecting an alarm into the system. Alarms, when escalated by the Alarm Management System (AMS), escalate from child to parent (e.g. from port 2 to ethernet) in the OMS tree. The properties of a managed object preferably include: name (such as a character string used to provide a human-readable reference to a managed object); user pointer (a pointer that can be used for any purpose); and an operational state.

The parent/child relationship of the OMS tree is used by the AMS 1 in the handling of alarms. In this regard, the parent of a managed object is notified of its alarms. As the parent of a managed object usually has a broader view of a system than a child object and, it can take actions that the child object would not be able to take during an alarm situation.

In the preferred embodiments of the present invention discussed in detail below, the parent managed object is notified of alarms regardless of whether the alarm has been cleared by the child managed object. The reasoning behind this escalation protocol is that a parent object may be interested in knowing that an alarm has been generated by a particular alarm source even though the alarm has already been cleared by a child object. However, in alternative embodiments of the present invention, a parent of a managed object may only be notified of an alarm if the managed object has not been able to clear the alarm.

The AIL 20 provides a common interface to both escalating and base systems. In a base system, the AIL 20 simply calls the system defined policy 70 (or the user policy 70, if present). In an escalating system, the AIL 20 provides information relating to the alarm to the alarm managers 30, (or 30′).

The alarm manager 30 is an alarm dispatching and filtering system that distributes the alarms received from AIL 20 to the alarm hook 50 and to the deferred dispatching mechanism provided within the alarm dispatcher task 60. In this regard, the alarm manager 30 examines the managed object that generated the alarm and calls the appropriate fault recovery mechanisms (e.g. hooks, handlers) as specified by the user.

A global alarm hook 50.1 may be provided so that actions independent of the source of the alarm can be performed. As an example, global hook 50.1 could keep track of all the alarms in the system. In addition, alarm hooks 50.2 can be provided which are specific to the source of the alarm. The global hook 50.2 (if implemented) should generally run after the alarm hook 50.2. The alarm hooks are the first recovery mechanism called by the alarm manager 30. The alarm hooks 50.1, 50.2 are called within the context of the AIL 20 and, as such, are subject to the normal constraints of interrupt/exception routines (as alarms can be injected at task, interrupt or exception levels). Preferably there is only one alarm hook 50.2 for each managed object.

As noted above, the AMS 1 provides access to a system default policy and a user default policy. The system default policy is provided by the system and is part of the core operating system. The user policy allows the user to override the existing system policy. When implemented, the user policy is invoked by the AIL 20 in the same manner as the system default policy.

The alarm manager 30 may call the user policy, for example, when the alarm hooks 50.1, 50.2 were not able to consume (i.e. clear) a particularly severe alarm. The user policy is a global policy and therefore is not specific to a single alarm source. Preferably, the user policy replaces the system default policy, and therefore, the Alarm Manager will not run the system policy if a user policy is specified. The system policy is also called directly by the AIL 20 when the system does not include an escalation layer.

The alarm dispatcher task 60 defers (usually at a lower priority) escalation work to the task level. Among other things, the alarm dispatcher task 60 is used to defer the work of the alarm handlers and to perform escalation. The alarm dispatcher task 60 is called after the alarm hook has executed and returned. The alarm dispatcher task can perform any work on behalf of any caller, and preferably has a user definable priority.

The alarm handlers 40 provide the deferred recovery process. Several alarm handlers can be associated to a managed object. Alarm handlers can also be sources of alarms, and therefore are treated as managed objects.

In the preferred embodiments of the present invention discussed in detail below, the alarm dispatcher task 60 (and therefore the alarm handlers) are invoked regardless of whether the alarm has been cleared by the alarm hook. However, in alternative embodiments of the present invention, the alarm dispatcher task 60 (and therefore the alarm handlers) may be invoked only if the alarm hook has not been able to clear the alarm.

Alarm hooks 50 and alarm handlers 40 present some similarities. The main difference is in their behavior, as the hook is run within the context of the source of the alarm, whereas the handler is run within the alarm dispatcher task context. However, they are similar as they are both defined by the users, they can be specific to a managed object, and they perform actions aimed to deal with the alarm that has been injected. Therefore in the following discussion they are often referred to collectively as alarm hook/handler.

An Alarm hook/handler can be related to a specific managed object. When a managed object is created, alarm hook/handlers can be registered with the object. As part of registration, an alarm handler may associate a filter along with the managed object. As described in more detail below, the filter defines the type of alarms of interest to the alarm handler. For example one could filter on the severity of the alarm or the type of the alarm. In any event, if the managed object has alarms that a hook/handler has manifested interested in (e.g. that it can respond to), then the hook/handler is registered with the object. Once the registration is performed, each time an alarm is injected from that managed object, the hook/handlers registered with it will be called (subject to any filters in the case of an alarm handler). An object might also be related to some other object in the system through a hierarchical dependency that is represented within the OMS 10. Therefore the Alarm Manager 30 not only calls the alarm hook 50 and alarm handlers 40 registered with the alarmed managed object, but also calls the alarm handlers 40 registered with the objects which are at a higher level in the hierarchy of the OMS 10 (i.e., the ancestors of the alarmed managed object).

The alarm structure supported by the AMS 1 is preferably based on the ITU X.733 standard, and implements what was deemed necessary by that standard to convey enough information about real-time systems' faults and to accommodate the performance and footprint requirements of a real-time operating system. Preferably, the alarm structure is as follows:

AlarmId: This parameter, when present, provides an identifier for the alarm, which may be used to further identify the alarm. Alarm identifiers are chosen to be unique across all alarms of a particular managed object throughout the time that the alarm is significant. The alarm identifier is chosen by the managed object injecting an alarm and is meaningful only to that managed object and other related, knowledgeable software systems such as alarm hooks, alarm handlers and other software entities that are dealing with the alarm.

timeStamp: The system timer time of the alarm creation. This parameter is set by AMS 1 upon receiving an alarm.

SourceId: The ID of the managed object that generated the alarm.

State: The state of the alarm, which can take one of two values: alarmSet—when the alarm has been set but has yet to be consumed; alarmClear—when the alarm has already been recovered from or dealt with (i.e. consumed). The Alarm Manager 30 (or 30′) initially sets the state of all alarms equal to AlarmSet. The various alarm hooks and alarm handlers are free to change that state afterwards.

Type: The alarm category, which can take one of the following values: 1) communicationsAlarm—An alarm of this type is principally associated with the procedures and/or processes required to convey information from one point to another; 2) qualityofServiceAlarm—An alarm of this type is principally associated with a degradation in the quality of a service, 3) processingErrorAlarm—An alarm of this type is principally associated with a software or processing fault, 4) equipmentAlarm—An alarm of this type is principally associated with an equipment fault, and 5) environmentalAlarm—An alarm of this type is principally associated with a condition relating to an enclosure in which the equipment resides.

ProbableCause: This parameter provides further information as to the probable cause of the alarm. Preferably, the 57 probable causes described in ITU X.733 are supported. These are as follows: error, adapterError, applicationSubsystemFailure, bandwidthReduced, callEstablishmentError, communicationProtocolError, communicationSubsystemFailure, configurationOrCustomizationError, congestion, corruptData, cpuCyclesLimitExceeded, datasetOrModemError, degradedSignal, dTE-DCEInterfaceError, enclosureDoorOpen, equipmentMalfunction, excessiveVibration, fileError, fireDetected, floodDetected, framingError, heatingOrVentilationOrCoolingSystemProblem, humidityUnacceptable, inputOutputDeviceError, inputDeviceError, lANError, leakDetected, localNodeTransmissionError, lossOfFrame, lossOfSignal, materialSupplyExhausted, multiplexerProblem, outOfMemory, outputDeviceError, performanceDegraded, powerProblem, pressureUnacceptable, processorProblem, pumpFailure, queueSizeExceeded, receiveFailure, receiverFailure, remoteNodeTransmissionError, resourceAtOrNearingCapacity, responseTimeExcessive, retransmissionRateExcessive, sofwareError, sofwareProgramAbnormallyTerminated, softwareProgramError, storageCapacityProblem, temperatureUnacceptable, thresholdCrossed, TimingProblem, toxicLeakDetected, transmitFailure, transmitterFailure, underlyingResourceUnavailable, versionMismatch, softwareNotification. Additional probable causes could, for example, include unknown, userDefined, and informational.

specificProblem: This parameter, when present, provides further information regarding the probable cause of the alarm. This parameter is preferably a user-defined integer code that is specified when a handler has identified a specific circumstance that caused the alarm. For example, when the probable cause is communicationSubsystemFailure, a specific problem could be “port is down” or “wire is disconnected.”

perceivedSeverity: This parameter can have the following values: alarmSevCleared—used to indicate the clearing of one or more previously reported alarms, alarmSevIndeterminate—used to generate an alarm that has no severity associated with it such as a debug alarm or information event (e.g. managed task exited), alarmSevWarning—used to generate a warning alarm which warns about something that could indicate future problems (e.g. 70% memory utilization threshold hit), alarmSevMinor—used to generate a minor alarm which describes an error condition that is probably recoverable (e.g. 70% memory utilization threshold is crossed), alarmSevMajor—used to generate a major alarm which describes an error condition that is potentially recoverable (e.g. task received a bus error), and alarmSevErrorCritical—used to generate an alarm describing an error condition that is definitely unrecoverable (e.g. work queue exhausted, NMI occurred, etc).

PAdditionalInformation: This parameter, when present, allows the inclusion of a set of additional information in the event report.

As described above, the AIL 20 is the entry point for the AMS 1. If a source wants to send an alarm to the system it can do it through the alarmInject routine. An exemplary alarmInject( ) API is set forth below, wherein the parameters correspond to the definition set forth above:

STATUS alarmInject

(

ALARM_SOURCE_ID sourceId,

ALARM_ID alarmId,

ALARM_TYPE type,

ALARM_PCAUSE pCause,

ALARM_SCAUSE sCause,

ALARM_SEVERITY severity,

ALARM_INFO * pAddInfo

)

The above-referenced function returns ERROR when i) the alarm cannot be deferred properly, ii) when the source of the alarm was not provided, or iii) when the AIL was not able to call the alarm manager and had to apply the default policy (either the user or system default policy). The Alarm Manager 30 and the Alarm Dispatcher Task 60 are the coordinators of the fault recovery activities which happen within the context of the alarmed source. The Alarm Manager 30 runs in the context of the alarmInjecto call, and is, re-entrant (an alarm handler might call alarmInject( ) itself). The Alarm Dispatcher Task 60 runs with a user configurable priority.

A description of the eight steps taken when an alarm is injected into the system of FIG. 1(a) is described below. The item numbers refer to the eight steps in FIG. 1(b).

1. AIL 20 receives the alarm through the alarmInject( ) API and verifies the existence of an escalation layer. If there is no escalation layer, AIL calls the system or user default policy.

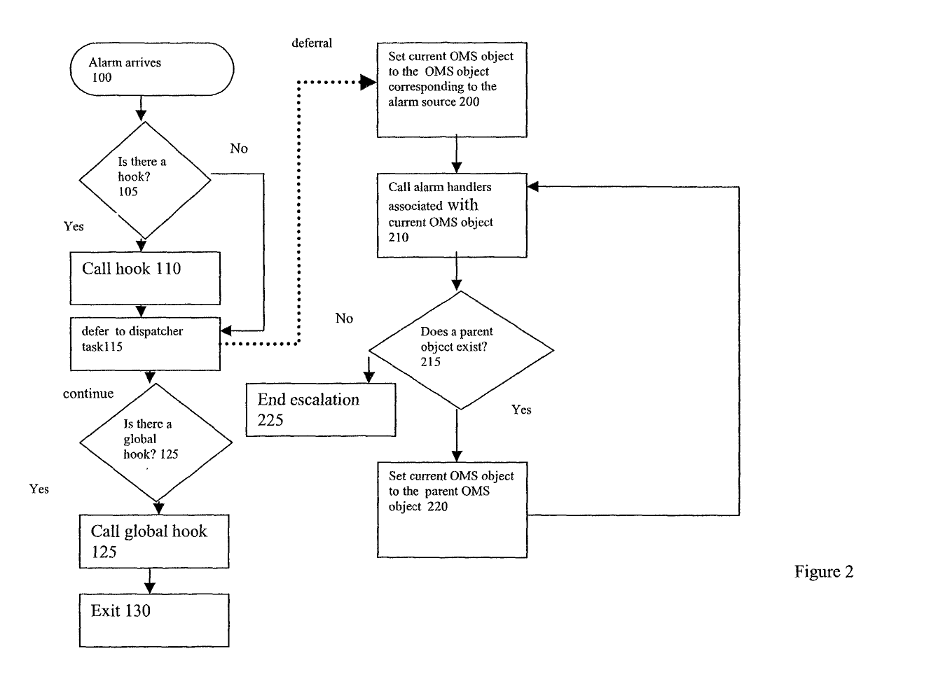

2. AIL 20 calls the alarm manager (see flow chart of FIG. 2, step 100). The parameters passed in to the alarm manager are identical to the parameters passed in to the alarmInject( ). The manager assigns a timestamp to the alarm so that alarms can be ordered in time. The timestamp can also be used for a timeout feature. An alarm is then created on a stack to be passed along for further processing.

3. The Alarm Manager calls the alarm hook associated with the alarm source, if any (FIG. 2, steps 105, 110).

4. After the alarm hook returns the alarm Manager is ready to defer and passes the alarm information to the alarm dispatcher task (FIG. 2, step 115).

5. If there is a global alarm hook, it is called (FIG. 2, steps 120, 125).

6. The alarm manager returns (FIG. 2, step 130).

7. The alarm dispatcher task takes the information passed to it by the alarm manager in step 5 (FIG. 2, step 115) and calls the alarm handlers (if any) associated with the alarm source. (FIG. 2, steps 200, 210). In the flow chart of FIG. 2, this is accomplished by setting a current managed object variable to the managed object corresponding to the alarm source, (step 200) and then calling the alarm handlers associated with the current managed object (step 210).

8. The alarm dispatcher task 60 performs any necessary escalation 61 of the managed object tree. In the flow chart of FIG. 2, the alarm dispatcher task determines whether an escalation is required by identifying the existence of any parent object of the current object in step 215. If a parent object exist, escalation is performed by setting the current managed object to the parent object, (step 220) and calling any alarm handlers associated with the current managed object (in this case, the parent) in step 210. If no parent managed object exists, the escalation is terminated (step 225).

It should be noted that the Alarm Manager processing is performed within the alarmInject( ) call context. The Alarm Manager allows the operating system to do the scheduling and preempt an alarm processing thread with other threads. For this reason, alarm hooks in this embodiment are re-entrant. In addition, alarm hooks could be callable from the interrupt level since alarmInject( ) can be called in any possible context (task level, interrupt level, exception level).

As described above with regard to FIGS. 1(b), and 2, when a managed object injects an alarm in the system, the alarm dispatcher task 60 not only calls the alarm handlers bound to the alarmed managed object, but also calls the alarm handlers bound to the ancestors of the alarmed managed object. The order of invocation by the dispatcher task 60 starts with the alarm handlers associated with the alarmed managed object, then the handlers registered with its parent, then the parent of the parent, up to and the root managed object.

FIG. 3(b) shows an example of escalation. In this example, assume that an alarm was injected for the managed object /oms/c1/c1c2 (“oms” is the parent of c1 which is the parent of c1c2), that the alarm handler AH1 has bound to c1 and c1c2, that the alarm handler AH2 only bound to the root managed object and that no global hook is implemented. The Alarm Manager 30 will then make the following calls.

1. The alarm hook of /oms/c1/c1c2 is called first with an alarmed object parameter set to the OMS id of /oms/c1/c1c2.

2. Control is passed to the Alarm dispatcher task 60 which controls escalation.

3. AH1 is then called with an alarmed object parameter set to the OMS id of /oms/c1/c1c2 and a calling object parameter set to the OMS id of /oms/c1/c1c2.

4. AH1 is then called with an alarmed object parameter set to /oms/c1/c1c2 and a calling object parameter set to the OMS id of /oms/c1. It should be noted that calling AH1 a second time is needed since the alarm is not in the same context as what was the case when it was called the first time. The calling object is not the same. This is significant because an alarm handler may perform different actions depending on the state of the alarm, the alarmed object, and the calling object.

5. AH2 is finally called with an alarmed object parameter set to /oms/c1/c1c2 and a calling object parameter set to the OMS id of /oms.

In certain embodiments of the present invention, the calling of an alarm handler is not only subject to alarm escalation, but also to filtering criteria. Filtering is used to minimize the number of calls made to alarm handlers, thereby preventing the alarm dispatcher task 60 from unnecessarily calling an alarm handler and reducing alarm handling latency. Although a wide variety of filtering criteria can be implemented in AMS, two specific types of filtering criteria will be discussed herein.

The first category is called alarm filtering. Upon registration, an alarm handler may provide a filter so that the alarm dispatcher task 60 will know what types of alarms are of interest to the alarm handler.

The second type of filtering is called sanity filtering. Before every call to an alarm handler, the alarm dispatcher task should make sure that the alarm handler to be called is functioning properly.

With regard to alarm filtering, AMS preferably filters alarms based on the alarm severity. As mentioned above, each alarm handler 40 can specify the alarm filters that are to be applied to it by the alarm dispatcher task 60. The alarm severity filter is defined when an alarm handler is initialized, but can preferably be changed subsequently to let alarm handlers adapt to particular situations.

Additional filtering can be provided within the alarm hook/handlers code. When an alarm is injected, all the attributes related to it can be accessed by the hook/handler. Therefore the hook/handler itself could decide to filter on the type, or alarmId or state, or any other attribute related to that alarm by simply taking no substantive action when it is called by the alarm dispatcher task.

In addition to providing alarm filtering, the system provides an alarm source designation for each hook/handler. The source designation is defined when the registration between the managed object and the handler (or hook) is created. The alarm handler can change the source of alarm by breaking the registration with the existing source and creating a new one. When a new source is created, it can notify the handler with an appropriate function (e.g. handler Alarm Create). The handler can then decide whether it is interested in that source and create a register with it. Similarly, an handlerAlarmnDelete function is provided to notify the handler when the source gets deleted.

With regard to sanity filtering, the Alarm Dispatcher Task verifies the handler state so that it can determine if it is ready to run. The handler state is an OMS defined attribute. For instance, a handler could have been temporarily disabled, even though it is still part of the handlers list. There are two types of sanity filtering that are preferably performed by the Alarm Manager.

First: The alarm dispatcher task 60 tries to detect feedback loops in alarm handlers by keeping a count of the number of times an alarm handler has been called in the same context (the count is incremented when the alarm handler is called and decremented when the alarm handler returns). This should also detect situations where the alarm handler does something wrong to the system and increases the number of alarmInject( ) calls. The threshold at which the alarm dispatcher task 60 takes actions against an alarm handler is user selectable. The corrective actions taken when the alarm dispatcher task 60 detects that an alarm handler in a feedback loop are as follows. The alarm dispatcher task 60 first creates a special alarm on a stack and calls the alarm hook associated with the alarm handler. If this clears the alarm, then no further actions are taken. If it does not clear the alarm, then the alarm handler is de-registered and its managed object is shut down (e.g., a SHUTDOWN message is sent to it). It should be noted that an alarm handler that has been shut down will have to re-register with the alarm dispatcher task 60 to be re-introduced into the list of active alarm handlers.

Second: The alarm dispatcher task keeps track of the number of outstanding alarms against the same managed object. The threshold defining when the alarm dispatcher task must take corrective actions is user selectable. The corrective actions taken when the alarm dispatcher task detects that a managed object is injecting too many alarms are as follows. The alarm dispatcher task first creates a special alarm on the stack and calls the alarm hook associated with the troubled object. If this clears the alarm, then no further actions are taken. If it does not clear the situation, then the managed object is shut down (e.g., a SHUTDOWN message is sent to it).

Timeouts can be used to avoid handlers blocking the alarm dispatcher task 60. If a timeout value is reached, the handler execution will be terminated and control will return to the alarm dispatcher task 60. The alarm dispatcher task 60 will then be in charge of restarting the handler execution, so that it can run the next ready handler. This would prevent blocking or unacceptable delays within the context of the alarm dispatcher task 60. This can be implemented, for example, in the manner described in copending U.S. application Ser. No. 09/738,786, filed Dec. 15, 2000, entitled “System and Method For Managing Client Process”, the entire disclosure of which is hereby incorporated by reference.

An exemplary structure through which the AMS 1 may keep information on the alarm handlers registered with it is shown in Table 1:

TABLE 1

| Field Name | Type | Description |
|---|---|---|
| OmsAlarmHandlerId | OMS_ID | Handlers can also be |
| | | sources of alarms, i.e. OMS |
| | | objects. Therefore this field |
| | | is used to represent the |
| | | alarm handler that has |
| | | registered with the Alarm |
| | | Manager. |
| Index | AH_INDEX | This integer between 0 and |
| | | 31 represents the alarm |
| | | handler in the AMS |
| | | handlers list. It is a |
| | | code used to rapidly |
| | | extract information about |
| | | this alarm handler. |
| AlarmFilter | ALARM_FILTER | This bit field is used to |
| | | filter alarms based on |
| | | the alarm severity. |
| PalarmHandler | FUNCPTR | This function pointer is |
| | | called when the handler is |
| | | bound to the alarmed |
| | | managed object or one of |
| | | its ancestors. |
| PCreateNotif | FUNCPTR | This function pointer is |
| | | called whenever a new |
| | | managed object is created. |
| PDeleteNotif | FUNCPTR | This function pointer is |
| | | called whenever a managed |
| | | object in which the alarm |
| | | handler was bound to is |
| | | deleted |
| BBusy | BOOL | Indicates that the structure |
| | | is in use. |

In the preferred embodiment of the present invention, each source of alarm (i.e. managed object) may have one alarm hook and any or all of the 32 allowable alarm handlers within the system. These alarm handlers will only be called if the severity of the alarm matches the registered severity identified any alarm filter for that handler.

The following function can be used to connect (i.e. register or bind) an alarm hook to a source of alarm, so that when an alarm is injected, the hook will be called. In this function, pPrevHook is used to return the value of the hook that is being registered.

STATUS amsAlarmHookBind

(

ALARM_SOURCE_ID sourceId

FUNCPTR alarmHook,

FUNCPTR* pPrevHook

)

The following function connects (i.e. registers or binds) an alarm handler to a source of alarm, so that when an alarm is injected the handler will be called.

STATUS amsAlarmHandlerBind

(

ALARM_HANDLER_ID handlerId,

ALARM_SOURCE_ID sourceId,

)

In any event, the alarm information can be passed to the handler/hook through the structure described above. A set of APIs can be used to retrieve the alarm ID, state, type, probable cause, specific problem, severity, timestamp, and additional info from the alarm structure.

The following discussion describes the generic steps that can be used to create an alarm handler in the AMS system. The alarm handler can be implemented with the following syntax: void handlerRoutine (ALARM *pAlarm, ALARM_SOURCE_ID callingObj, int distance). This routine is run within the context of the Alarm Dispatcher Task, and will be called whenever there is an alarm in a managed object to which this alarm handler is bound. The pAlarm pointer refers to the structure of the injected alarm. The callingObj is the ID of the current managed object within the escalation process. The distance is the number of nodes needed to be traversed from managed object which generated the alarm to the current callingObj.

For example, suppose the alarmed object is /oms/c1/c1c and that this alarm handler was bound to /oms/c1 but not in /oms/c1/c1c1. In this case, the call to the handler will be made by the alarm dispatcher task when doing fault escalation and looking at /oms/c1. In that case, the callingObj parameter is set to the ID of /oms/c1, the alarm structure contains information related to the node /oms/c1/c1c1, and the distance is 1.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. An alarm management system, comprising:
a hierarchical database of alarm source identifiers, each alarm source identifier being associated with a corresponding software entity capable of generating an alarm;
an alarm processor, the alarm processor receiving an alarm from one of the software entities, invoking a corresponding alarm controller for the one of the software entities, accessing the hierarchical database to identify a parent software entity of the one of the software entities, and invoking a corresponding alarm controller for the parent software entity.

2. The alarm management system of claim 1, further comprising an alarm manager, wherein the alarm processor invokes the corresponding alarm controller for the one of the software entities, accesses the hierarchical database to identify the parent software entity of the one of the software entities, and invokes the corresponding alarm controller for the parent software entity via the alarm manager.

3. The alarm management system of claim 1, wherein the alarm includes an alarm source identifier.

4. The alarm management system of claim 1, wherein the alarm processor, upon receiving the alarm, creates a time stamp for the alarm.

5. The alarm management system of claim 3, wherein the alarm source identifier is unique to the software entity generating the alarm during a lifetime of the alarm.

6. The alarm management system of claim 3, wherein the alarm includes an alarm state, the alarm state being one of an alarm cleared and an alarm set.

7. The alarm management system of claim 1, wherein the alarm includes an AlarmId, timeStamp, SourceId, state, type, ProbableCause, and perceivedSeverity in accordance with ITU X.733.

8. The alarm management system of claim 6, wherein the alarm further includes a specificProblem in accordance with ITU X.733.

9. The alarm management system of claim 1, wherein each alarm controller is a software entity capable of generating an alarm, and the hierarchical database includes an alarm source identifier corresponding to the alarm controller.

10. The system of claim 1, wherein the alarm processor invokes the corresponding alarm controller for the parent software entity regardless of whether the alarm was cleared by the one of the software entities.

11. The system of claim 1, wherein the alarm processor does not invoke the parent software entity if the alarm was cleared by the one of the software entities.

12. The system of claim 1, wherein the alarm processor accesses the hierarchical database before it invokes the corresponding alarm controller for the one of the software entities.

13. The system of claim 1, wherein the alarm processor accesses the hierarchical database after it invokes the corresponding alarm controller for the one of the software entities.

14. An alarm management system, comprising:
a hierarchical database of alarm source identifiers, each alarm source identifier being associated with a corresponding software entity capable of generating an alarm;
a corresponding alarm hook for each software entity;
a plurality of alarm handlers, each software entity being associated with at least one of the alarm handlers;
an alarm processor, the alarm processor receiving an alarm from one of the software entities and invoking the corresponding alarm hook,
invoking the at least one alarm handler for the one of the software entities,; and
accessing the hierarchical database to identify a parent software entity of the one of the software entities based upon the alarm source identifier associated with the one of the software entities, and
invoking the at least one alarm handler associated with the parent software entity.

15. The alarm management system of claim 14, wherein the alarm includes an alarm source identifier.

16. The alarm management system of claim 15, wherein the alarm processor, upon receiving the alarm, creates a time stamp for the alarm.

17. The alarm management system of claim 15, wherein the alarm includes an alarm identifier, the alarm identifier being unique to the software entity generating the alarm during a lifetime of the alarm.

18. The alarm management system of claim 15, wherein the alarm includes an alarm state, the alarm state being one of an alarm cleared and an alarm set.

19. The alarm management system of claim 14, wherein the alarm includes an AlarmId, timeStamp, SourceId, state, type, ProbableCause, and perceivedSeverity in accordance with ITU X.733.

20. The alarm management system of claim 19, wherein the alarm further includes a specificProblem in accordance with ITU X.733.

21. A method for responding to an alarm comprising:
receiving an alarm from one of a plurality of software entities,
identifying a parent software entity of the one of the software entities,
invoking a corresponding alarm controller for the one of the software entities;
and invoking a corresponding alarm controller for the parent software entity.

22. The method of claim 21, wherein the step of identifying the parent software entity further comprises
accessing a hierarchical database of alarm source identifiers, each alarm source identifier being associated with a corresponding software entity of the plurality of software entities; and
identifying the parent software entity based upon the alarm source identifier associated with the one of the software entities.

23. The method of claim 22, wherein the alarm includes an alarm source identifier.

24. The method of claim 22, further comprising the step of, upon receiving the alarm, creating a time stamp for the alarm.

25. The method of claim 23, wherein the alarm includes an alarm identifier, the alarm identifier being unique to the software entity generating the alarm during a lifetime of the alarm.

26. The method of claim 23, wherein the alarm includes an alarm state, the alarm state being one of an alarm cleared and an alarm set.

27. The method of claim 22, wherein the alarm includes an AlarmId, timeStamp, SourceId, state, type, ProbableCause, and perceivedSeverity in accordance with ITU X.733.

28. The method of claim 27, wherein the alarm further includes a specificProblem in accordance with ITU X.733.

29. The method of claim 21, wherein the step of invoking a corresponding alarm controller for the one of the software entities is performed before the identifying step.

30. The method of claim 21, wherein the step of invoking a corresponding alarm controller for the present software entity is not performed if the alarm is cleared by the one of the plurality of software entities.

31. A method for responding to an alarm comprising:
receiving an alarm from one of a plurality of software entities and invoking a corresponding alarm hook;
invoking at least one alarm handler associated with the one of the software entities;
accessing a hierarchical database of alarm source identifiers, each alarm source identifier being associated with a corresponding software entity of the plurality of software entities;
identifying a parent software entity of the one of the software entities based upon the alarm source identifier associated with the one of the software entities; and
invoking at least one alarm handler associated with the parent software entity.

32. The method of claim 31, wherein the step of receiving an alarm further comprises associating the alarm with the one of the plurality of software entities by accessing the hierarchical database.

33. The method of claim 31, wherein the alarm includes an alarm source identifier.

34. The method of claim 31, farther comprising the step of, upon receiving the alarm, creating a time stamp for the alarm.

35. The method of claim 33, wherein the alarm includes an alarm identifier, the alarm identifier being unique to the software entity generating the alarm during a lifetime of the alarm.

36. The method of claim 33, wherein the alarm includes an alarm state, the alarm state being one of an alarm cleared and an alarm set.

37. The method of claim 31, wherein the alarm includes an AlarmId, timeStamp, SourceId, state, type, ProbableCause, and perceivedSeverity in accordance with ITU X.733.

38. The method of claim 37, wherein the alarm further includes a specificProblem in accordance with ITU X.733.

39. The method of claim 31, wherein the step of invoking farther comprising applying filtering criteria to the alarm and invoking the at least one alarm handler associated with the one of the software entities, and the at least one alarm handler associated with the parent software entity, if the filtering criteria are satisfied.

40. The method of claim 39, wherein the filtering criteria applied to the at least one alarm handler associated with the one of the software entities is different than the filtering criteria applied to the at least one alarm handler associated with the parent software entity.

41. An alarm management system, comprising:
a plurality of software entities capable of generating an alarm;
a hierarchical database of alarm source identifiers, each alarm source identifier being associated with a corresponding one of the software entities;
a plurality of alarm hooks, each alarm hook being associated with one of the software entities;
a plurality of alarm handlers, each alarm handler being associated with one or more of the software entities; and
an alarm processor, the alarm processor
receiving an alarm from one of the software entities and invoking any alarm hook associated with the one of the software entities,
invoking any alarm handlers associated with the one of the software entities,
accessing the hierarchical database to identify a parent software entity of the one of the software entities based upon the alarm source identifier associated with the one of the software entities; and
invoking any alarm handlers associated with the parent software entity.

42. The alarm management system of claim 41, wherein the alarm includes an alarm source identifier.

43. The alarm management system of claim 42, wherein the alarm processor, upon receiving the alarm, creates a time stamp for the alarm.

44. The alarm management system of claim 42, wherein the alarm includes an alarm identifier, the alarm identifier being unique to the software entity generating the alarm during a lifetime of the alarm.

45. The alarm management system of claim 42, wherein the alarm includes an alarm state, the alarm state being one of an alarm cleared and an alarm set.

46. The alarm management system of claim 41, wherein the alarm includes an AlarmId, timeStamp, SourceId, state, type, ProbableCause, and perceivedSeverity in accordance with ITU X.733.

47. The alarm management system of claim 46, wherein the alarm further includes a specificProblem in accordance with ITU X.733.

48. The system of claim 41, wherein the alarm processor
accesses the hierarchical database to identify a parent software entity of the parent software entity based upon the alarm source identifier associated with the parent software entity, and
invokes any alarm handlers associated with the parent software entity of the parent software entity of the one of the software entities.

49. The method of claim 31, further comprising the steps of
identifying a parent software entity of the parent software entity of the one of the software entities based upon the alarm source identifier associated with the parent software entity of the parent software entity of the one of the software entities; and
invoking the at least one alarm handler associated with the parent software entity of the parent software entity of the one of the software entities.

50. The system of claim 41, wherein the alarm processor
accesses the hierarchical database to identify each ancestor software entity of the parent software entity, and
invokes any alarm handlers associated with each ancestor software entity of the parent software entity of the one of the software entities.

51. The method of claim 31, further comprising the steps of
identifying each ancestor software entity of the parent software entity of the one of the software entities; and
invoking the at least one alarm handler associated with each ancestor software entity of the parent software entity of the one of the software entities.

52. The system of claim 1, wherein the alarm processor accesses the hierarchical database to identify each ancestor software entity of the parent software entity of the one of the software entities, and invokes any alarm controllers corresponding each ancestor software entity.

53. The system of claim 1, further comprising a processor, wherein the alarm processor executes on the processor.

54. A computer readable medium, having stored thereon, computer executable process steps operative to control a computer, the computer executable process steps comprising:
receiving an alarm from one of a plurality of software entities,
identifying a parent software entity of the one of the software entities,
invoking a corresponding alarm controller for the one of the software entities;
and invoking a corresponding alarm controller for the parent software entity.

55. The computer readable medium of claim 54, wherein the step of identifying the parent software entity further comprises
accessing a hierarchical database of alarm source identifiers, each alarm source identifier being associated with a corresponding software entity of the plurality of software entities; and
identifying the parent software entity based upon the alarm source identifier associated with the one of the software entities.

56. The computer readable medium of claim 55, wherein the alarm includes an alarm source identifier.

57. The computer readable medium of claim 55, further comprising the step of, upon receiving the alann, creating a time stamp for the alarm.

58. The computer readable medium of claim 56, wherein the alarm includes an alarm identifier, the alarm identifier being unique to the software entity generating the alarm during a lifetime of the alarm.

59. The computer readable medium of claim 56, wherein the alarm includes an alarm state, the alarm state being one of an alarm cleared and an alarm set.

60. The computer readable medium of claim 55, wherein the alarm includes an AlarmId, timeStamp, SourceId, state, type, ProbableCause, and perceivedSeverity in accordance with ITU X.733.

61. The computer readable medium of claim 60, wherein the alarm further includes a specificProblem in accordance with ITU X.733.

62. The computer readable medium of claim 54, wherein the step of invoking a corresponding alarm controller for the one of the software entities is performed before the identifying step.

63. The computer readable medium of claim 54, wherein the step of invoking a corresponding alarm controller for the present software entity is not performed if the alarm is cleared by the one of the plurality of software entities.

64. A computer readable medium, having stored thereon, computer executable process steps operative to control a computer, the computer executable process steps comprising:
receiving an alarm from one of a plurality of software entities and invoking a corresponding alarm hook;
invoking at least one alarm handler associated with the one of the software entities;
accessing a hierarchical database of alarm source identifiers, each alarm source identifier being associated with a corresponding software entity of the plurality of software entities;
identifying a parent software entity of the one of the software entities based upon the alarm source identifier associated with the one of the software entities; and
invoking at least one alarm handler associated with the parent software entity.

65. The computer readable medium of claim 64, wherein the step of receiving an alarm further comprises associating the alarm with the one of the plurality of software entities by accessing the hierarchical database.

66. The computer readable medium of claim 64, wherein the alarm includes an alarm source identifier.

67. The computer readable medium of claim 64, further comprising the step of, upon receiving the alarm, creating a time stamp for the alarm.

68. The computer readable medium of claim 66, wherein the alarm includes an alarm identifier, the alarm identifier being unique to the software entity generating the alarm during a lifetime of the alarm.

69. The computer readable medium of claim 66, wherein the alarm includes an alarm state, the alarm state being one of an alarm cleared and an alarm set.

70. The computer readable medium of claim 64, wherein the alarm includes an AlarmId, timestamp, SourceId, state, type, ProbableCause, and perceivedSeverity in accordance with ITU X.733.

71. The computer readable medium of claim 70, wherein the alarm further includes a specificProblem in accordance with ITU X.733.

72. The computer readable medium of claim 64, wherein the step of invoking further comprising applying filtering criteria to the alarm and invoking the at least one alarm handler associated with the one of the software entities, and the at least one alarm handler associated with the parent software entity, if the filtering criteria are satisfied.

73. The computer readable medium of claim 72, wherein the filtering criteria applied to the at least one alarm handler associated with the one of the software entities is different than the filtering criteria applied to the at least one alarm handler associated with the parent software entity.
